(19) United States
(12) Patent Application Publication
(10) Pub. No.: US 2026/0104026 A1
(43) Pub. Date: Apr. 16, 2026

(54) FUEL FILTER

(71) Applicant: MAHLE International GmbH, Stuttgart (DE)

(72) Inventors: Alexandru Bogdan Ostafe, Timisoara (RO); Uli Haeussermann, Fellbach (DE); Sorin Jadaneantu, Timis (RO)

(21) Appl. No.: 19/356,038

(22) Filed: Oct. 10, 2025

(30) Foreign Application Priority Data
Oct. 11, 2024 (DE) 102024129393.4

(51) Int. Cl. F02M 37/34; B01D 27/08; B01D 29/21

(52) U.S. Cl. CPC F02M 37/34; B01D 27/08; B01D 29/21; B01D 2201/40

(57) ABSTRACT

A fuel filter for a motor vehicle may include a housing and a filter element arranged in the housing coaxially. The filter element may include a hollow-cylindrical filter body, a hollow-cylindrical radially permeable support collar, and two end plates. The filter body and the support collar may be oriented coaxially to one another and/or may be arranged between the two end plates. The support collar may be arranged inside the filter body and/or the filter body may be supported radially inward by the support collar. The support collar may include at least one axially permeable groove facing the filter body such that the filter element is axially permeable between the support collar and the filter body via the at least one groove.

### CROSS-REFERENCE TO RELATED APPLICATION

This application claims priority to German Patent Application No. DE102024129393.4, filed on Oct. 11, 2024, the contents of which is hereby incorporated by reference in its entirety.

### TECHNICAL FIELD

The invention relates to a fuel filter for filtering a fuel for a motor vehicle, comprising a housing and a filter element.

### BACKGROUND

A fuel filter typically comprises a housing and a filter element arranged within the housing. The filter element comprises a filter body made of a filter material and divides the housing into a filtered side and an unfiltered side. The fuel to be filtered then flows in the housing from the unfiltered side to the filtered side via the filter material of the filter body and is filtered. The filter element is often hollow-cylindrical and comprises an interior. Other elements of the fuel filter—such as an outlet neck—may be arranged in the interior of the filter element. If the fuel flows through the filter element radially from the outside to the inside, the elements in the interior may impair the flow of fuel.

### SUMMARY

It is therefore an object of the invention to provide, for a fuel filter of the generic type, an improved or at least alternative embodiment by which the disadvantages described are overcome.

According to the invention, this object is achieved by the subject matter of independent claim(s). Advantageous embodiments are the object of the dependent claim(s).

The fuel filter according to the invention is configured for filtering a fuel for a motor vehicle. The fuel filter comprises a housing and a filter element arranged in the housing coaxially to its longitudinal central axis. The filter element comprises a hollow-cylindrical filter body and a radially permeable hollow-cylindrical support collar. Furthermore, the filter element comprises two end plates oriented axially or perpendicular to the longitudinal central axis, wherein the filter body and the support collar are arranged coaxially to one another and between the end plates. The support collar is arranged inside the filter body and the filter body is supported radially inward by the support collar. The support collar also comprises at least one axially permeable groove facing the filter body, such that the filter element is axially permeable through the at least one groove between the support collar and the filter body.

The fuel in the filter element may flow axially through the groove in the support collar independently of other elements arranged inside the filter element—such as an outlet neck. This allows the filter capacity of the fuel filter to be increased and the pressure differences within the filter body or an interior of the filter element bounded by the filter body to the outside to be equalized.

In a possible embodiment of the fuel filter, the support collar may comprise at least one supporting rib circumferentially surrounding the longitudinal central axis and at least one axially oriented support rib. The at least one supporting rib and the at least one supporting rib may be connected to one another. The at least one groove may be formed in the at least one supporting rib. The at least one groove may be formed in the at least one supporting rib facing the filter body and oriented radially inward.

In this embodiment it may be provided that, along a circumferential direction encircling the longitudinal central axis, an extent of all grooves formed in the at least one supporting rib amounts to at most 50% of an overall circumference of the at least one supporting rib. This ensures that, despite the grooves in the at least one supporting rib, the filter body is still adequately supported radially inward by the support collar. In particular, this may reduce the risk of the filter element collapsing.

In this embodiment, it may be provided that the support collar comprises a plurality of supporting ribs spaced axially apart from one another. In at least two of the supporting ribs, the at least one groove is formed in each case. The at least one groove in the one supporting rib and the at least one groove in the other axially adjacent supporting rib may be formed offset from one another in a circumferential direction encircling the longitudinal central axis. In particular, the grooves in the axially adjacent supporting ribs may be arranged in a checkerboard pattern to one another. This ensures that the filter body is supported along the longitudinal central axis at least at some of the supporting ribs. In particular, this may reduce the risk of the filter element collapsing.

In this embodiment it may be provided that, outside the at least one groove, the at least one supporting rib comprises at least one recess facing the filter body and oriented radially inward. The filter body may be formed as a pleated body having a plurality of axially oriented pleats. At least one pleat of the filter body may then lie in the at least one recess and thereby be fixed in a circumferential direction encircling the longitudinal central axis. In particular, this may prevent the individual pleats of the filter body from shifting in the circumferential direction, thereby stabilizing the filter element.

In a possible embodiment of the fuel filter, the filter element may comprise a sealing tube. The sealing tube may be arranged inside the support collar and coaxially to the support collar. The support collar may then be supported radially inward by the sealing tube. The sealing tube may be connected to one end plate of the filter element, preferably in a materially bonded manner, and may be axially spaced apart from the other end plate. In particular, the sealing tube may be provided to safely separate the filtered side and the unfiltered side of the fuel filter, and also support the support collar.

In this embodiment, it may be provided that all grooves of the support collar are formed in the region between the filter body and the sealing tube. This allows fuel to flow out from the region between the support collar and the sealing tube and allow pressure differences within an interior formed in the filter body to be equalized.

In this embodiment, it may be provided that the fuel filter comprises a hollow-cylindrical outlet neck. The outlet neck may then be arranged coaxially and, at least partially, in the filter element. The outlet neck may furthermore lead out of the housing at an axial longitudinal end of the housing and extend axially through the sealing tube of the filter element. The sealing tube may then bear circumferentially and in a fluid-tight manner against the outlet neck. In particular, the sealing tube may rest against the outlet neck at an axial distance from the longitudinal end at which the outlet neck extends outward. The filtered side and the unfiltered side can then be separated from each other at an axial distance from the longitudinal end at which the outlet neck extends outward. This prevents the unfiltered fuel from reaching the filtered side when changing the filter element and prevents contamination of the filtered fuel with the unfiltered fuel when changing the filter element.

In the context of the present invention, the terms “axial” and “radial” and “coaxial” and “circumferential” always refer to the longitudinal central axis of the housing. In the fuel filter, the housing and/or the filter body and/or the support collar and/or the sealing tube and/or the outlet neck may be oriented coaxially to one another. The phrase “within a hollow-cylindrical element” is synonymous with the phrase “in a cavity formed within the hollow-cylindrical element”.

Further important features and advantages of the invention will become apparent from the dependent claims, from the drawings, and from the associated description of the figures with reference to the drawings.

It is understood that the features mentioned above and those to be explained below may be used not only in the combination indicated in each case, but also in other combinations or on their own, without departing from the scope of the present invention.

Preferred exemplary embodiments of the invention are shown in the drawings by way of example and are explained in more detail in the following description, wherein identical reference signs refer to identical or similar or functionally identical elements.

### BRIEF DESCRIPTION OF THE DRAWINGS

It shows, schematically in each case

FIG. 1 shows a sectional view of a fuel filter according to the invention;

FIG. 2 shows a sectional view of a filter element of the fuel filter according to the invention;

FIGS. 3 through 5 show a view and enlarged partial views of a support collar of the filter element of the fuel filter according to the invention;

FIG. 6 shows a partial sectional view of the filter element of the fuel filter according to the invention;

FIG. 7 shows a top view of the support collar of the filter element of the fuel filter according to the invention.

### DETAILED DESCRIPTION

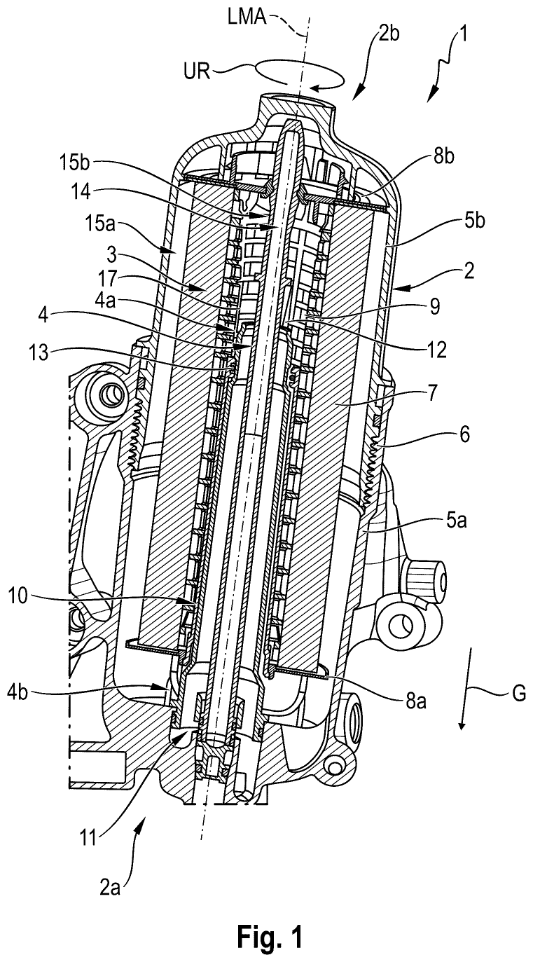

FIG. 1 shows a sectional view of a fuel filter 1 according to the invention for filtering a fuel for a motor vehicle. Fuel filter 1 comprises a housing 2, a hollow-cylindrical filter element 3, and a hollow-cylindrical outlet neck 4. In FIG. 1, the fuel filter (1) is oriented in an operational position with respect to the force of gravity G.

The housing 2 comprises a first longitudinal end 2a and a second longitudinal end 2b, which are axially spaced apart with respect to a longitudinal central axis LMA of the housing 2. The housing 2 further comprises a first housing part 5a having the first longitudinal end 2a, and a second housing part 5b having the second longitudinal end 2b, which are detachably connected—in this case screwed—to one another at a circumferential connection point 6.

The filter element 3 comprises a hollow-cylindrical filter body 7, a first end plate 8a and a second end plate 8b, a hollow-cylindrical support collar 9, and a sealing tube 10. The sealing tube 10 is arranged inside the support collar 9 and the support collar 9 is arranged inside the filter body 8. The filter body 7, the support collar 9, and the sealing tube 10 are arranged coaxially with respect to each other and axially between the end plates 8a and 8b aligned perpendicular to the longitudinal central axis LMA. The filter body 7 and the support collar 9 extend over the entire axial height of the filter body 7 and are connected to the end plates 8a and 8b. The filter body 7 is supported radially inwardly on the support collar 9 and the support collar 9 is supported radially inwardly on the sealing tube 10. The sealing tube 10 is connected to the first end plate 8a—welded, for example−and extends approximately over an axial center of the filter body 7. The filter element 3 is arranged coaxially in the housing 2, such that the filter body 7, the support collar 9, and the sealing tube 10 are oriented coaxially to the housing 2.

The outlet neck 4 is arranged in sections within the sealing tube 10 of the filter element 3 and is aligned coaxially with the housing 2 and the filter element 3. The outlet neck 4 is in fluid communication, at its first axial end 4a, with an outlet 11 of the housing 2 formed at the first longitudinal end 2a, and protrudes out of the sealing tube 10 at its second axial end 4b. At the second end 4b, the outlet neck 4 comprises an inlet opening 12, which leads from an interior 17 of the filter element 3 into the outlet neck 4. The sealing tube 10 bears externally against the outlet neck 4, such that a circumferential sealing seat 13 is formed between the sealing tube 10 or the filter element 3 and the outlet neck 4. A vent tube 14 of the fuel filter 1 is also arranged coaxially inside the outlet neck 4. The vent tube 14 connects the outlet 11 of the housing 2 with the surroundings at the second longitudinal end 2b of the housing 2.

Fuel filter 1 is configured to filter the fuel. The fuel flows to an unfiltered side 15a of the housing 2 and through the filter body 7 of the filter element 3 to a filtered side 15b of the housing 2. The unfiltered side 15a of the housing 2 here comprises a region surrounding the filter element 3 on the outside, and a region arranged between the first longitudinal end 2a of the housing 2 and the end plate 8a of the filter element 3. Furthermore, the unfiltered side 15a here comprises a region that is arranged between the sealing tube 10 and the outlet neck 4, and extends axially from the first end plate 8a to the sealing seat 13.

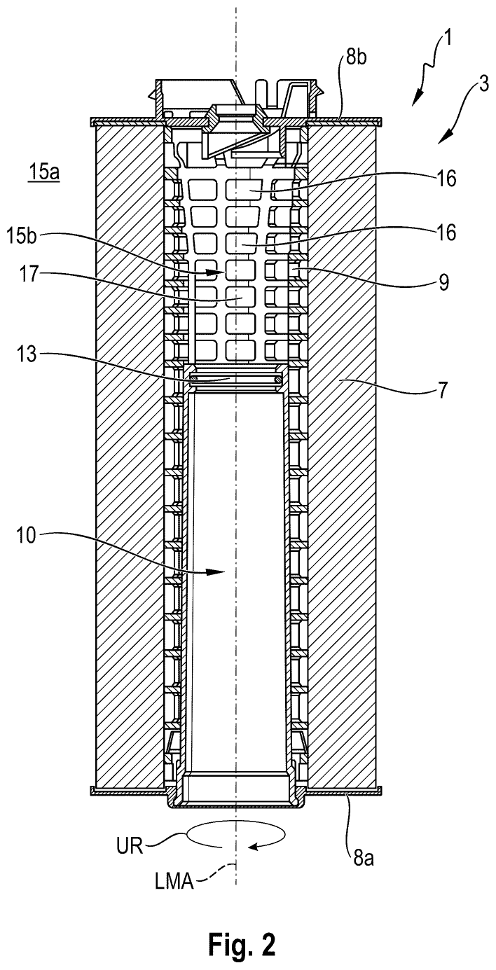

FIG. 2 shows a sectional view of the filter element 3 of the fuel filter 1 according to the invention. As can be seen particularly clearly here, the sealing tube 10 does not extend over the entire axial height of the filter body 7.

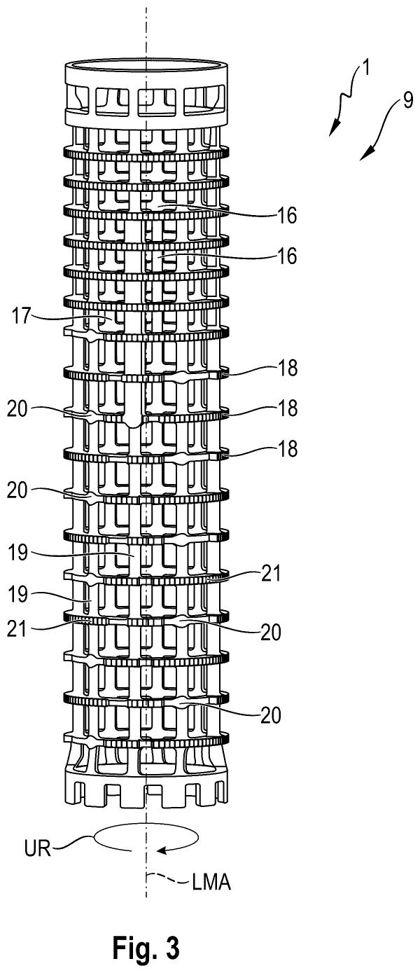

FIG. 3 shows a view of the support collar 9 of the filter element 3 of the fuel filter 1 according to the invention. As can be seen particularly clearly in FIG. 3, the support collar 9 comprises several circumferential supporting ribs 18 and a plurality of support ribs 19. The supporting ribs 18 are formed so as to extend circumferentially around the longitudinal central axis (LMA) and are arranged axially spaced apart from one another. The supporting ribs 18 are therefore ring-shaped. The support ribs 19 are axially aligned with one another and arranged at a distance from one another in a circumferential direction UR encircling the longitudinal central axis LMA. The supporting ribs 18 and the support ribs 19 are connected to each other such that the support collar 9 stabilizes the filter body 7 and the filter element 3 as a whole. The supporting ribs 18 lie radially outward on the support ribs 19 and are arranged radially adjacent to the filter body 7. Openings 16 are formed between the supporting ribs 18 and the supporting ribs 19. The fuel filtered in the filter body 7 may enter the interior 17 of the filter element 3 through the openings 16.

A plurality of grooves 20 are formed on the supporting ribs 18. The grooves 20 are formed in the supporting ribs 18 facing the filter body 7 and are directed radially inward. This allows axial flow through the grooves 20 and the filter element 3 between the filter body 7 and the support collar 9. The grooves 20 are formed in the region of the support collar 9, which is radially opposite the sealing tube 10. The fuel that flows into the interior 17 opposite the sealing tube 10 may thus be directed axially to the inlet opening 12 of the outlet neck 4. In particular, this may reduce the pressure in the region between the support collar 9 and the sealing tube 10.

FIG. 4 and FIG. 5 show partial views of the support collar 9 of the filter element 3 of the fuel filter 1 according to the invention. As can be seen particularly clearly in FIG. 4 and FIG. 5, the grooves 20 in the supporting ribs (18) that are axially adjacent to one another are offset from one another in the circumferential direction (UR) and arranged here in a checkerboard pattern. By offsetting the grooves 20 in the circumferential direction (UR), each pleat of the filter body 7 may be supported on the support cage 9 along the longitudinal central axis (LMA). Between the grooves 20, several formations 21 are furthermore formed on the supporting ribs 18, which additionally prevent displacement of the pleats of the filter body 7 in the circumferential direction (UR). Accordingly, the grooves 20 may on the one hand permit axial outflow of the fuel, and on the other hand the recesses 21 may stabilize the filter element 3.

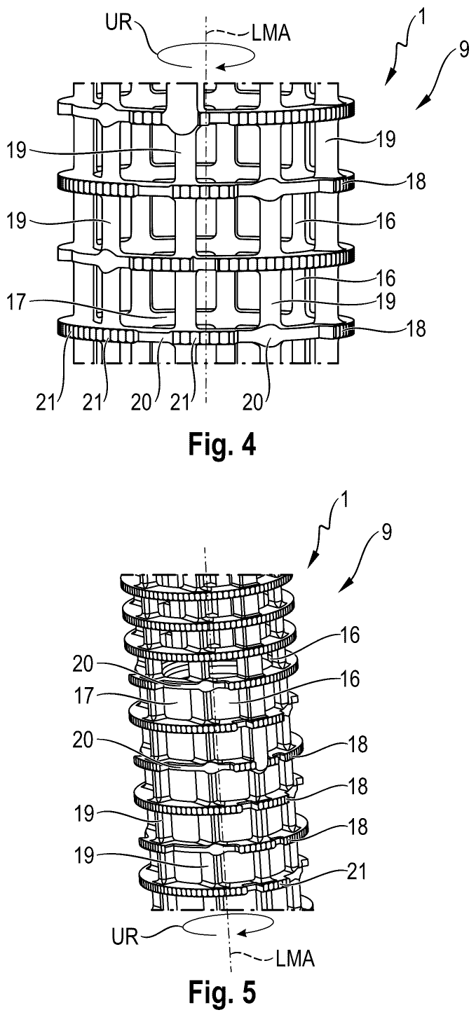

FIG. 6 shows a partial sectional view of the filter element 3 of the fuel filter 1 according to the invention. In FIG. 6 it is particularly easy to see that the grooves 20 between the filter body 7 and the support collar 9 form axially permeable flow channels 22.

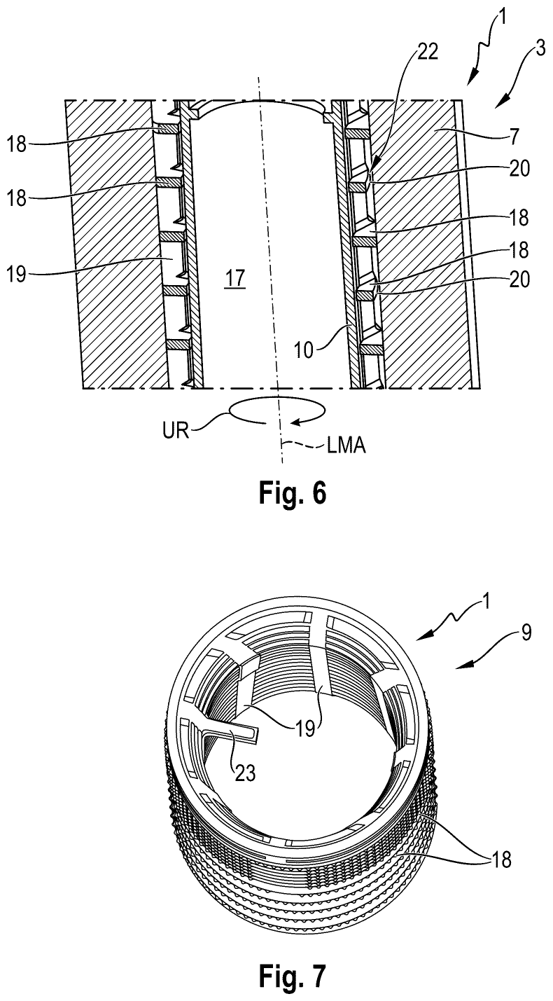

FIG. 7 shows a top view of the support collar 9 of the filter element 3 of the fuel filter 1 according to the invention. FIG. 7 shows a guide element 23 of the support collar 9. Referring to FIG. 1, when the filter element 3 is inserted into the housing 2, the guide element 23 slides along the outlet neck 4 and engages a complementary recess of the outlet neck 4 in a predefined rotational position in the manner of a key-lock principle. As a result, the filter element 3 may be positioned in the housing 2 in the defined rotational position with respect to the longitudinal central axis LMA and in a rotationally fixed manner.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A fuel filter for a motor vehicle, comprising:
a housing; and
a filter element arranged in the housing coaxially to a longitudinal central axis of the housing, the filter element including:
a hollow-cylindrical filter body;
a hollow-cylindrical radially permeable support collar; and
two end plates;
wherein the filter body and the support collar are oriented coaxially to one another and arranged between the two end plates;
wherein the support collar is arranged inside the filter body and the filter body is supported radially inward by the support collar; and
wherein the support collar includes at least one axially permeable groove facing the filter body such that the filter element is axially permeable between the support collar and the filter body via the at least one groove.

2. The fuel filter according to claim 1, wherein:
the support collar further includes:
at least one supporting rib encircling the longitudinal central axis; and
at least one axially extending support rib;
the at least one supporting rib and the at least one support rib are connected to one another; and
the at least one groove is formed in the at least one supporting rib.

3. The fuel filter according to claim 2, wherein, along a circumferential direction encircling the longitudinal central axis, an extent of the at least one groove is 50% or less of a total circumference of the at least one supporting rib.

4. The fuel filter according to claim 2, wherein:
the at least one supporting rib includes a plurality of axially spaced-apart supporting ribs;
the at least one groove includes a plurality of grooves that are each formed in a respective supporting rib of the plurality of supporting ribs; and
a first groove of the plurality of grooves is formed in a first supporting rib of the plurality of supporting ribs, a second groove of the plurality of grooves is formed in a second supporting rib of the plurality of supporting ribs disposed axially adjacent to the first supporting rib, and the first groove and the second groove are arranged offset from one another in a circumferential direction encircling the longitudinal central axis.

5. The fuel filter according to claim 4, wherein axially adjacent grooves of the plurality of grooves are arranged offset from one another such that the plurality of grooves form a checkerboard pattern.

6. The fuel filter according to claim 2, wherein:
the at least one supporting rib includes at least one radially inwardly oriented recess facing the filter body and arranged outside of the at least one groove;
the filter body is a pleated body with a plurality of axially extending pleats; and
at least one pleat of the plurality of pleats lies in the at least one recess fixing the at least one pleat in a circumferential direction encircling the longitudinal central axis.

7. The fuel filter according to claim 1, wherein:
the filter element further includes a sealing tube arranged inside the support collar and disposed coaxially with the support collar; and
the support collar is supported radially inward via the sealing tube.

8. The fuel filter according to claim 7, wherein the sealing tube is connected to a first end plate of the two end plates of the filter element and is arranged axially spaced from a second end plate of the two end plates.

9. The fuel filter according to claim 7, wherein the at least one groove of the support collar is arranged in a region between the filter body and the sealing tube.

10. The fuel filter according to claim 7, further comprising a hollow-cylindrical outlet neck arranged coaxially and at least partially in the filter element, wherein:
the outlet neck extends outward from the housing at an axial longitudinal end of the housing and passes axially through the sealing tube of the filter element; and
the sealing tube contacts the outlet neck in a circumferential and fluid-tight manner.

11. The fuel filter according to claim 1, wherein the support collar further includes:
a plurality of annular supporting ribs extending circumferentially around the longitudinal central axis, the plurality of annular supporting ribs disposed axially spaced apart from one another; and
a plurality of axial support ribs connecting the plurality of annular supporting ribs to one another, the plurality of axial support ribs disposed circumferentially spaced apart from one another.

12. The fuel filter according to claim 11, wherein the plurality of annular supporting ribs are disposed at least partially on a radially outer side of the plurality of axial support ribs.

13. The fuel filter according to claim 11, wherein a plurality of openings via which fluid is flowable into an interior of the filter element are defined by and between the plurality of annular supporting ribs and the plurality of axial support ribs.

14. The fuel filter according to claim 11, wherein the at least one groove includes a plurality of grooves that are each disposed in and defined by a respective annular supporting rib of the plurality of annular supporting ribs.

15. The fuel filter according to claim 14, wherein at least two grooves of the plurality of grooves are disposed in and defined by a single annular supporting rib of the plurality of annular supporting ribs.

16. The fuel filter according to claim 14, wherein axially adjacent grooves of the plurality of grooves are arranged offset from one another such that the plurality of grooves form a checkerboard pattern.

17. The fuel filter according to claim 14, wherein at least one annular supporting rib of the plurality of annular supporting ribs includes a plurality of radially outward projecting formations engaged with the filter body and restricting movement of the filter body in at least a circumferential direction relative to the longitudinal central axis.

18. The fuel filter according to claim 17, wherein:
the filter body is a pleated body; and
the plurality of formations define a plurality of recesses configured to engage a pleat of the pleated body.

19. The fuel filter according to claim 14, wherein:
the filter element further includes a sealing tube arranged at least partially within the support collar; and
the plurality of grooves are each arranged in a region of the support collar disposed radially between the filter body and the sealing tube.

20. The fuel filter according to claim 19, wherein the plurality of grooves from a plurality of axially permeable flow channels between the filter body and the sealing tube.
